(19) United States
(12) Patent Application Publication
(10) Pub. No.: US 2026/0244294 A1
(43) Pub. Date: Aug. 20, 2026

(54) TOUCH SCREEN SCANNING USING A COMBINATION OF MULTI-FREQUENCY AND MULTI-PHASE ELECTRODE EXCITATION

(71) Applicant: Cypress Semiconductor Corporation, San Jose, CA (US)

(72) Inventors: ROMAN OGIRKO, Lviv (UA); Oleksandr Karpin, Lviv (UA)

(73) Assignee: Cypress Semiconductor Corporation, San Jose, CA (US)

(21) Appl. No.: 19/058,961

(22) Filed: Feb. 20, 2025

(51) Int. Cl. G06F 3/041; G06F 3/044

(52) U.S. Cl. CPC G06F 3/04166; G06F 3/0446

(57) ABSTRACT

An apparatus includes sinusoidal wave generators configured to generate, over a signal bus coupled to transmission (TX) electrodes of a touch sensor, multiple sets of drive signals at different frequency and phase combinations. Control circuits, coupled to the sinusoidal wave generators, control, based on a frequency of a clock signal, timing of generation of the multiple sets of drive signals. Control logic causes a first drive signal, generated by a first sinusoidal wave generator at a first frequency and a set of phases, to be applied to a first group of the TX electrodes. The control logic causes a second drive signal, generated by a second sinusoidal wave generator at a second frequency and the set of phases, to be applied to a second group of the TX electrodes.

### TECHNICAL FIELD

Embodiments of the present invention relate to the field of user interface devices and, in particular, to touch screen scanning using a combination of multi-frequency and multi-phase electrode excitation.

### BACKGROUND

Computing devices, such as notebook computers, personal data assistants (PDAs), and mobile handsets, have user interface devices, which are also known as human interface devices (HID) and include a touch sensor. One type of user interface device that has become more common is touch-sensing devices, such as touch-sensor pads (also commonly referred to as touchpads), touch-sensor sliders, touch-sensor buttons, touch-sensor keyboard, touchscreens, and touch panels all of which can be considered to include a touch sensor.

A basic notebook touch-sensor pad emulates the function of a personal computer (PC) mouse. A touch-sensor pad is typically embedded into a PC notebook for built-in portability. A touch-sensor pad replicates mouse x/y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a pointer or selecting an item on a display.

Another user interface device that has become more common is a touch screen. Touch screens, also known as touchscreens, touch panels, or touchscreen panels are display overlays, which are typically pressure-sensitive (resistive), electrically sensitive (capacitive), acoustically sensitive (SAW-surface acoustic wave), or photo-sensitive (infra-red). The effect of such overlays allows a display to be used as an input device, removing the keyboard and/or the mouse as the primary input device for interacting with the display's content. Such displays can be attached to computers or, as terminals, to networks. There are several types of touch screen technology, such as optical imaging, resistive, surface wave, capacitive, infrared, dispersive signal, and strain gauge technologies. Touch screens have become familiar in retail settings, on point-of-sale systems, automatic teller machines, mobile handsets, game consoles, and personal digital assistants. A stylus is sometimes used to manipulate the graphical user interface (GUI) and to enter data.

In general, capacitance-sensing devices are intended to replace mechanical buttons, knobs, and other similar mechanical user-interface controls. Capacitance-sensing devices eliminate the complicated mechanical switches and buttons, providing reliable operation under harsh conditions. In addition, capacitance-sensing devices are widely used in modern customer applications, providing new user interface options in the existing products. Capacitive touch sensor elements can be arranged in the form of a sensor array for a touch-sensing surface. When a conductive object, such as a finger, comes in contact or close proximity with the touch-sensing surface, the capacitance of one or more capacitive touch sensor elements changes. An electrical circuit can measure the capacitance changes of the capacitive touch sensor elements. The electrical circuit, supporting one operation mode, converts the measured capacitances of the capacitive touch sensor elements into digital values.

Each sensor element uses at least two electrodes: one is a transmission (TX) electrode (also referred to herein as transmitter electrode), and the other is a receiving (RX) electrode. When a finger touches a sensor element or is in close proximity to the sensor element, the capacitive coupling between the receiver and the transmitter of the sensor element is decreased as the finger shunts part of the electric field to ground (e.g., chassis or earth). Such as decrease in capacitance can be sensed (e.g., measured) as a touch at a particular sensor element (also referred to as a capacitive unit).

### BRIEF DESCRIPTION OF THE DRAWINGS

The present disclosure is illustrated by way of example, and not by way of limitation, in the figures of the accompanying drawings.

FIG. 1A is a schematic block diagram of a capacitance-sensing apparatus, device, or system with circuitry that drives a touch sensor with a multi-phase signal using differential waveforms according to some embodiments.

FIG. 1B is a graph illustrating a frequency response after a single measurement when employing multi-phase TX excitation and deconvolution (MPTX) technology according to some embodiments of FIG. 1A.

FIGS. 2A-2B are a schematic block diagram of a capacitance-sensing apparatus, device, or system with circuitry that drives a touch sensor with multi-frequency waveforms according to some embodiments.

FIG. 2C is a graph illustrating a frequency response after a single measurement when employing multi-frequency TX excitation and deconvolution (MFTX) technology according to some embodiments, of FIGS. 2A-2B.

FIG. 3A is a schematic TX electrode-based flow diagram illustrating timing of excitation, at different frequency and phase combinations, different groups of TX electrodes according to some embodiments.

FIG. 3B is a schematic block diagram illustrating the grouping of TX electrodes in active slots and at least one passive slot according to some embodiments.

FIG. 4 is a signal timing graph illustrating timing of operation of drive signals of different frequencies being applied to different groups of electrodes in relation to a measurement period and a measurement window according to some embodiments.

FIG. 5 is a flow chart illustrating a method of implementing a control logic that controls each of at least some of the sinusoidal wave generators that generate drive signals at different frequencies according to the timing explained with reference to FIG. 4 according to some embodiments.

FIGS. 6A-6B are a schematic block diagram of a capacitance-sensing apparatus, device, or system with circuitry that drives a touch sensor with multi-frequency and multi-phase signals according to some embodiments.

FIG. 7 is a timing graph associated with the schematic TX electrode-based flow diagram of FIG. 3A illustrating timing of different control signals on generating the multi-frequency and multi-phase excitation technology according to exemplary embodiments.

FIG. 8A is a schematic circuit diagram illustrating an exemplary TX electrodes multiplexer driver for implementing the apparatus, device, or system of FIG. 6A-6B according to some embodiments.

FIG. 8B is an example memory for storing different phase patterns corresponding to groups of electrodes to implement the MPTX technology through the exemplary TX electrodes multiplexer driver (FIG. 8A) according to some embodiments.

FIG. 8C is an example memory for storing different frequencies corresponding to the groups of electrodes to implement the MFTX technology through the exemplary TX electrodes multiplexer driver (FIG. 8A) according to some embodiments.

FIG. 9A is a flow chart of a method for operating an apparatus (or device or system) of exciting a touch sensor so as to employ both MPTX and MFTX technologies on groups of electrodes according to some embodiments.

FIG. 9B is a flow chart of a method for operating the apparatus (or device of system) so as to control timing of generation of digital sinusoidal signals, corresponding to the MPTX and MFTX drive signals (FIG. 9A), for use in demodulation by a signal processing unit coupled to RX electrodes of the apparatus (or device or system) according to some embodiments.

FIG. 10 illustrates an embodiment of a core architecture of the PSoC® processing device, such as that used in the PSoC3® family of products offered by Cypress Semiconductor Corporation (San Jose, California).

### DETAILED DESCRIPTION

Some touch sensing applications (such as automotive, industrial, flight, or the like) configured touch sensors for high sensitivity to support thick overlay, operation in glove, operation at noisy conditions generated by the display (especially if on-cell sensors are located close to the display components), switching some inductive loads, radio emission, and the like. In addition, the emission of the touch sensor is limited, limiting the excitation energy of the touch sensor, making it difficult to achieve enough signal-to-noise ratio (SNR) to support high sensitivity required to discern noise from an actual touch.

A current trend in the automotive industry is the use of large touchscreen displays in entertainment or information systems. A high refresh rate of up to 120 Hz (or even 240 Hz) may be required to maintain fast response times and smooth operation. Increasing the size of the display increases the number of TX electrodes of the sensor. The increased number of TX electrodes together with the increased refresh rate makes the measurement window shorter. The measurement window is the period during which the measurement channel interacts with the touch sensor to obtain readings. A short measurement window has a wide bandwidth for noise, resulting in poor performance.

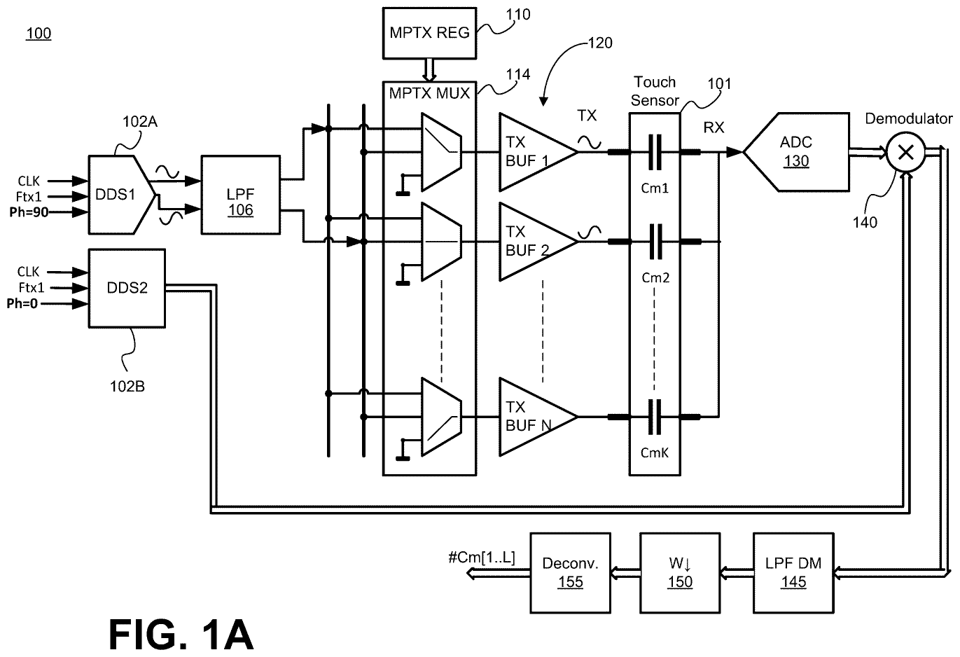

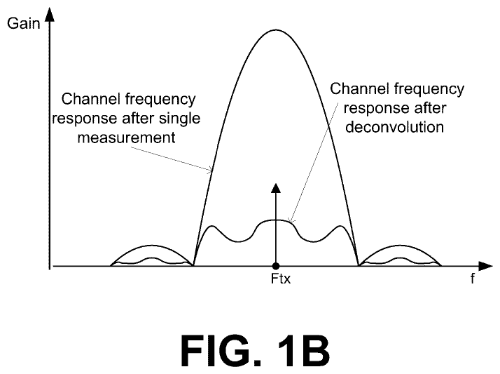

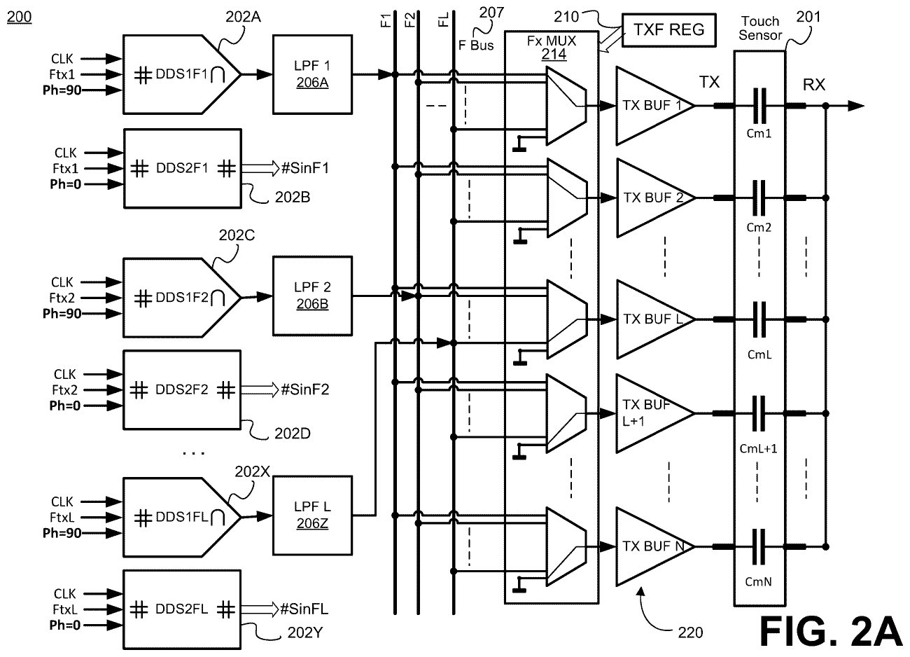

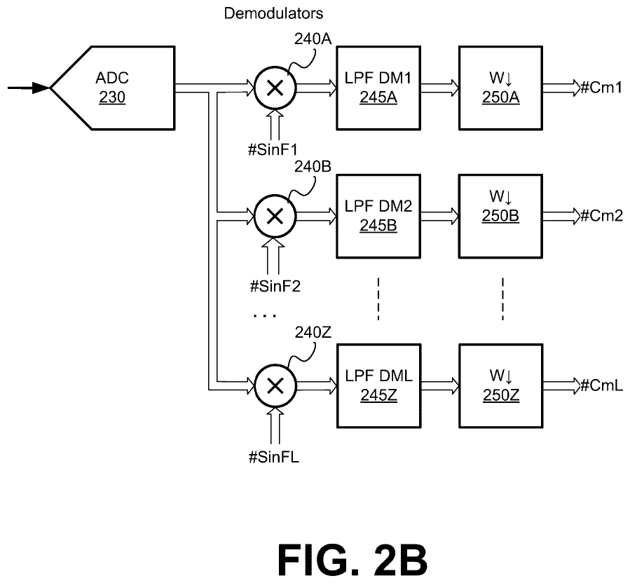

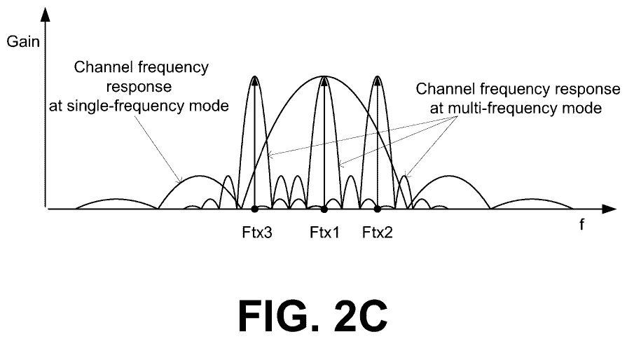

Aspects of the present disclosure and embodiments overcome the deficiencies above and others by increasing the frequency of updating the measured data at the TX/RX electrode crossings and improving the quality of measurements (SNR, resolution, etc.) by using frequency separation of TX channels (via MFTX) in combination with multi-phase excitation technology (MPTX). In some embodiments, disclosed architectures employ multiple (or Lf) frequencies for the touch sensor excitation (see MFTX approach of FIGS. 2A-2C), where each frequency is applied to a slot (or group) of electrodes whose phase of excitation signal is manipulated as in existing MPTX techniques (see FIGS. 1A-1B) using a number of combinations (Lm) of the phase patterns. The combination of employing MPTX and MFTX techniques enables narrowing down the bandwidth of the measurement channel due to increasing by Lf the measurement window duration and increasing the efficiency of the measurement system according to the criterion determined by the product of the factors that increase resolution and reduce noise of touch sensor measurements. These and other advantages apparent to those skilled in the art will be discussed in more detail.

In some embodiments, for example, an apparatus (or device or system) includes a plurality of sinusoidal wave generators configured to generate, over a signal bus coupled to TX electrodes of a touch sensor, multiple sets of drive signals at different frequency and phase combinations. Control circuits, coupled to the sinusoidal wave generators, may control, based on a frequency of a clock signal, timing of generation of the multiple sets of drive signals. Control logic may cause a first drive signal, generated by a first sinusoidal wave generator at a first frequency and a set of phases, to be applied to a first group of the TX electrodes. The control logic may cause a second drive signal, generated by a second sinusoidal wave generator at a second frequency and the set of phases, to be applied to a second group of the TX electrodes.

In embodiments, the control circuits also control timing of generation of corresponding digital sinusoidal signals, by the plurality of sinusoidal wave generators, for use in corresponding demodulation by a signal processing unit coupled to a plurality of RX electrodes of the touch sensor. In embodiments, the control logic causes a first digital sinusoidal signal corresponding to the first drive signal to be provided to the signal processing unit and causes a second digital sinusoidal signal corresponding to the second drive signal to be provided to the signal processing unit.

In various embodiments, a system includes an analog-to-digital converter (ADC) coupled to a receiving (RX) electrode of a touch sensor that is capacitively coupled to the TX electrodes. An RX circuit can be coupled to the ADC. In embodiments, the RX circuit includes a plurality of multipliers, each to demodulate a digital signal received from the ADC using a digital sinusoidal signal at a phase-shifted one of a plurality of frequencies used to excite a group of the plurality of TX electrodes. A plurality of low-pass filters (LPFs) can be coupled to the plurality of multipliers. In embodiments, each LPF generates a direct-current (DC) signal of the demodulated digital signal received from a multiplier of the plurality of multipliers.

It should be noted that the capacitance-sensing circuitry can detect conductive objects and other objects (also referred to as touch objects). An object, or touch object, is any object that disturbs the electrical field and reduces the coupling between the receiver and transmitter electrodes for the capacitance sensing techniques. For example, if a user touches the touch surface wearing gloves, the capacitance-sensing circuitry may not detect the user's finger as a conductive object, but the capacitance-sensing circuitry can still detect the user's finger because the user's finger still disturbs the electrical field and reduces the coupling between the electrodes. It should also be noted that the embodiments described herein can be used on touch sensors or panels having more than two transmitter electrodes and receiver electrodes as described below. Also, the capacitance-sensing circuitry can detect a hover event of a conductive object above the touch sensor or panel.

The following description sets forth numerous specific details, such as examples of specific systems, components, methods, and so forth, in order to provide a good understanding of several embodiments of the present invention. However, it will be apparent to one skilled in the art that at least some embodiments of the present invention may be practiced without these specific details. In other instances, well-known components or methods are not described in detail or presented in a simple block diagram format to avoid unnecessarily obscuring the present invention. Thus, the specific details set forth are merely exemplary. Particular implementations may vary from these exemplary details and still be contemplated to be within the spirit and scope of the present invention.

References in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

FIG. 1A is a schematic block diagram of a capacitance-sensing apparatus 100 (or device or system) with circuitry that drives a touch sensor 101 with a multi-phase signal using differential waveforms according to some embodiments. In embodiments, the apparatus 100 includes a first sinusoidal wave generator 102A and a second sinusoidal wave generator 102B each also known as a direct digital synthesizer (DDS). The first sinusoidal wave generator 102A can generate a differential analog output having excitation signals of opposite phases, e.g., an in-phase drive signal and an opposite-phase drive signal, which can be applied to adjacent electrodes of the touch sensor 101. The second sinusoidal wave generator 102B can generate a digital output comprising a signal for demodulation by a multiplier 140 (or demodulator) at the same frequency as the first sinusoidal wave generator 102A, but with a 90° phase shift.

In embodiments, the apparatus 100 further includes a low-pass filter or LPF 106 coupled to the output of the first sinusoidal wave generator 102A. The LPF 106 can be a smoothing filter to suppress harmonics generated by a digital-to-analog (DAC) discrete signal of the first sinusoidal wave generator 102A. The apparatus 100 can further include a MPTX multiplexer 114 configured to operate under control of values read out of an MPTX register 110 to distribute the excitation signals on the TX line of each TX electrode of the touch sensor 101. The MPTX register 110 can store a matrix of multi-phase values assigned to different electrodes at different time slots. If the length of the MPTX sequence (Lm) is less than the number of sensor TX lines (N), slot-by-slot scanning can be used, where excitation is not applied to some slots.

In embodiments, the apparatus 100 includes multiple TX buffers 120, each coupled to a different TX electrode of the touch sensor 101. An ADC 130 can be coupled to a plurality of RX electrodes to oversample the current coming from each RX electrode so as to measure for capacitance changes. A multiplier 140 (or demodulator) can be coupled to an output of the ADC 130 to perform synchronous demodulation of the ADC signal using the phase-shifted digital output generated by the second sinusoidal wave generator 102B. A low-pass filter (LPF) demodulator 145 can be coupled to an output of the multiplier 140 to form a DC signal from the demodulated ADC signal. The double bandwidth of the LPF demodulator 145 can determine the bandwidth of the measurement channel. The apparatus 100 can further include a down sampler 150 to get a measurement reading after converting the sensor signal during a measurement window. The apparatus 100 can further include a deconvolution unit 155 to restore the signal value of each TX electrode after converting the convoluted sensor signal by multi-phase excitation.

The MPTX architecture that can be employed can include simultaneous excitation of the TX lines with signals of the same frequency while manipulating the phase of different TX electrodes. This MPTX approach can be followed by a deconvolution procedure to recover the signal from each TX electrode. This MPTX architecture can be employed to reduce noise. According to this method, several TX electrodes are excited with signals of the same frequency with successive manipulation of their phases. The ADC 130 can receive the sum of the signals from the excited TX electrodes or converts the convoluted signal of a group of TX electrodes. A deconvolution procedure can be performed to restore the signal from each TX electrode. As a result, the channel bandwidth remains unchanged compared to the classic single phase/electrode excitation (SPTX), but its sensitivity to noise is attenuated. Thus, the MPTX architecture effectively attenuates the interference in the passband, but due to the rather wide passband, MPTX does not enable the ability to tune the measurement channel to a quiet narrow frequency band.

FIG. 1B is a graph illustrating a frequency response after a single measurement when employing multi-phase TX excitation and deconvolution (MPTX) technology according to some embodiments of FIG. 1A. The bandwidth for noise is the same as for a single measurement, but the noise is attenuated by approximately √Lm, where Lm is the length of the MPTX sequence. In embodiments, using MPTX approach uses the simplicity of cost effectiveness of a single frequency that generates a single frequency bandpass channel. As a disadvantage, however, use of the MPTX approach requires extended dynamic range due to increased signal magnitude determined by the sum of the MPTX sequence.

FIGS. 2A-2B are a schematic block diagram of a capacitance-sensing apparatus 200 (or device or system) with circuitry that drives a touch sensor 201 with multi-frequency waveforms according to some embodiments. According to this MFTX method, in some embodiments, each TX line is excited by a signal whose frequency (Fx) is different from all other frequencies. By using the TX separation in frequency, the apparatus 200 can increase the measurement time proportionally to the number of frequencies used (or Lf). A longer measurement time narrows the channel bandwidth. In embodiments, the implementation of this MFTX method requires a certain number of excitation signal generators and a multiband receiver for each RX line.

For example, in some embodiments, the apparatus 200 includes sets of sinusoidal wave generators, one for each TX electrode (or group of TX electrodes). For example, the apparatus 200 can include a first sinusoidal wave generator 202A to generate a first drive signal to be applied to a first TX electrode. In embodiments, the first drive signal can include a differential pair of drive signals, one in-phase and the other opposite-phase. The apparatus 200 can include a second sinusoidal wave generator 202B to generate a first digital output comprising a signal for demodulation by a first demodulator 240A at the same frequency as the first sinusoidal wave generator 202A, but with a 90° phase shift. The apparatus 200 can include a first LPF 206A to apply a smoothing filter to suppress harmonics.

The apparatus 200 can further include a third sinusoidal wave generator 202C to generate a third drive signal to be applied to a second TX electrode. In embodiments, the second drive signal can include a differential pair of drive signals, one in-phase and the other opposite-phase. The apparatus 200 can include a fourth sinusoidal wave generator 202D to generate a second digital output comprising a signal for demodulation by a second demodulator 240B at the same frequency as the second sinusoidal wave generator 202C, but with a 90° phase shift. The apparatus 200 can include a second LPF 206B to apply a smoothing filter to suppress harmonics.

The apparatus 200 can further include at least a penultimate sinusoidal wave generator 202X to generate a final drive signal to be applied to a final TX electrode. The apparatus 200 can include a final sinusoidal wave generator 202Y to generate a final digital output comprising a signal for demodulation by a final demodulator 140Z at the same frequency as the penultimate sinusoidal wave generator 202X, but with a 90° phase shift. The apparatus 200 can include a final LPF 206Z to apply a smoothing filter to suppress harmonics.

In embodiments, the apparatus 200 further includes multi-frequency (Fx) multiplexer component 214 configured to distribute the excitation signals on the TX lines of the touch sensor 201. If the number of sinusoidal wave generators is less than the number of sensor TX lines (N), slot-by-slot scanning is used, where excitation is not applied to some slots. This MFTX operation can be determined by values stored in a frequency memory 210 (TXF REG). The apparatus 200 can further include a plurality of TX buffers, each coupled to an output of a MUX of the Fx multiplexer component 214 and to drive one of the TX lines having a TX electrode.

In some embodiments, with additional reference to FIG. 2B, the apparatus 200 includes an ADC 230 to oversample the current coming each respective RX electrode (or RX line). The apparatus 200 may further include a plurality of multipliers, each coupled to the ADC 230, e.g., a first multiplier 240A coupled to the first RX electrode, a second multiplier 240B coupled to the second RX electrode, and a final multiplier 240Z coupled to a final RX electrode. Each multiplier can perform synchronous demodulation of the ADC signal using the digital output signals (# SinF1, # SinF2, . . . # SinFL, respectively). The apparatus 200 can further include a plurality of LPF demodulators, each coupled a respective one of the plurality of multipliers. For example, a first LPF demodulator 245A can be coupled to the first multiplier 240A, a second LPF demodulator 245B can be coupled to the second multiplier 240B, and a final LPF demodulator 245Z can be coupled to the final multiplier 240Z. Each LPF demodulator can low-pass filter the demodulated signal from a respective multiplier to form a DC signal from the demodulated ADC signal. The doubled bandwidth of each LPF demodulator filter can determine the bandwidth of the measurement channel.

In embodiments, the apparatus 200 includes a plurality of down samplers to get a measurement reading after converting the sensor signal during a measurement window. For example, the apparatus can include a first down sampler 250A coupled to the first LPF demodulator 245A, a second down sampler 250B coupled to the second LPF demodulator 245B, and so forth through a final down sampler 250Z coupled to the final LPF demodulator 245Z.

FIG. 2C is a graph illustrating a frequency response after a single measurement when employing multi-frequency TX excitation and deconvolution (MFTX) technology according to some embodiments, of FIGS. 2A-2B. In some embodiments, the MFTX method illustrated in FIGS. 2A-2B separates the TX electrodes by simultaneously exciting the TX electrodes with different frequencies. As a result, the measurement window can be expanded in the number of used frequencies, while maintaining the desired update frequency. The bandwidth for noise narrows in proportion to the number of frequencies used, but the sensitivity to noise within the bandwidth does not change. While MPTX technology reduces sensitivity to narrowband noise by attenuating the bandwidth by a factor of √Lm, the MFTX architecture narrows the bandwidth by a factor of Lf, reducing wideband noise by a factor of √Lf.

Thus, the MFTX architecture generates a narrowband channel that advantageously enables better tuning to a quiet frequency of the noise spectrum. The MFTX architecture, however, requires an expansion of the dynamic range due to an increase in the magnitude of the signal as the sum of the magnitudes of the excitation signals at different frequencies. The magnitude of each excitation signal should be reduced by Lf times compared to a single-frequency channel of the same dynamic range. The noise spectrum does not always contain quiet frequencies, the number of which is equal to or greater than the number of frequencies for excitation, reducing the efficiency and flexibility of operation if employing solely the MFTX method.

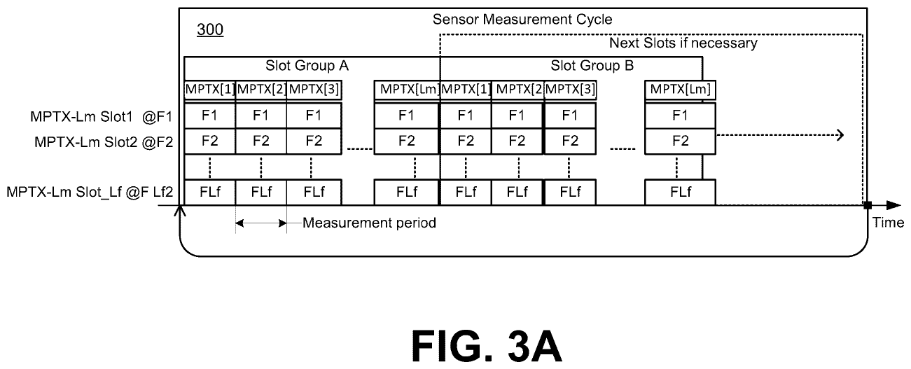

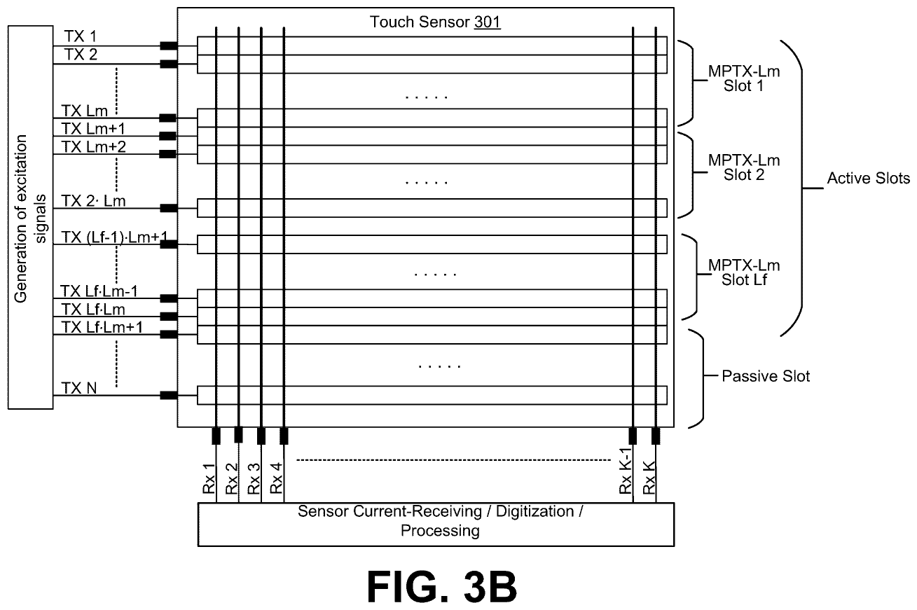

FIG. 3A is a schematic TX electrode-based flow diagram 300 illustrating timing of excitation, at different frequency and phase manipulation, different groups of TX electrodes according to some embodiments. FIG. 3B is a schematic block diagram illustrating the grouping of TX electrodes in active slots and at least one passive slot according to some embodiments. To incorporate the advantages of the MPTX and MFTX architectures while minimizing (or avoiding) the disadvantages, the present disclosure seeks to update the measured data at the TX/RX electrode crossings and improve the quality of measurements (SNR, resolution, etc.) by using frequency separation of TX channels (MFTX) in combination with multi-phase excitation technology (MPTX).

In some embodiments, as illustrated by the flow diagram 300, disclosed architectures employ multiple (or Lf) frequencies for the touch sensor excitation (see MFTX approach of FIGS. 2A-2C), where each frequency is applied to a slot (or group) of electrodes whose phase of excitation signal is manipulated as in existing MPTX techniques (see FIGS. 1A-1B) using a number of combinations (Lm) of the phases patterns. The combination of employing MPTX and MFTX techniques enables narrowing down the bandwidth of the measurement channel and increasing the efficiency of the measurement system according to the criterion determined by the product of the factors that increase resolution and reduce noise of touch sensor measurements.

With more specificity and reference to FIGS. 3A-3B, the flow diagram 300 illustrates a sensor measurement cycle in which the TX electrodes are organized into groups of active slots, each having Lm electrodes and excited with a separate frequency using Lm combinations of phases in accordance with the MPTX architecture. The size of the group of slots can be determined by the product of the length of the multi-phase sequence Lm by the number of used frequencies Lf. Thus, Lm·Lf could be equal to or less than the number of TX electrodes in a touch sensor 101.

For example, an initial Slot Group A (see FIG. 3A) can include a first group of TX1-TXLm electrodes (see FIG. 3B) associated with an active Slot 1 that operates at first frequency (F1), a second group of TX Lm_1 to TX2·Lm electrodes associated with an active Slot 2 that operates at a second frequency (F2), and a third group of TX (Lf−1)·Lm+1 to TX Lf·Lm+1 electrodes associated with an active Slot Lf that operates a final frequency (Lf) of available frequencies. Thus, each group of Lm electrodes can operate at a different frequency while being successively stepped through different phases according MPTX.

Further, as illustrated in FIG. 3B, there may also exist a passive slot of N TX electrodes that could not be excited due to being outside of the range of available frequencies and Lm electrodes available to the Active Slot A. For example, if Lm·Lf is less than the number of TX electrodes (N), the next slot or sequence of slots is scanned in the same way, e.g., Slot Group B of Lm TX electrode groups illustrated in FIG. 3A can be excited for measurement or scanned next while Slot Group A of Lm TX electrode groups becomes passive. If the size of the last active slot exceeds the size of the touch sensor 301, the last electrode of the active slot is placed on the last electrode of the touch sensor 301, and a certain number of the first electrodes of the active slot overlap the last electrodes of the previous slot. Therefore the RX electrode collects responses of the touch sensor unit-cells on some multi-phase pattern at different frequencies associated with different slots (or different slot groupings).

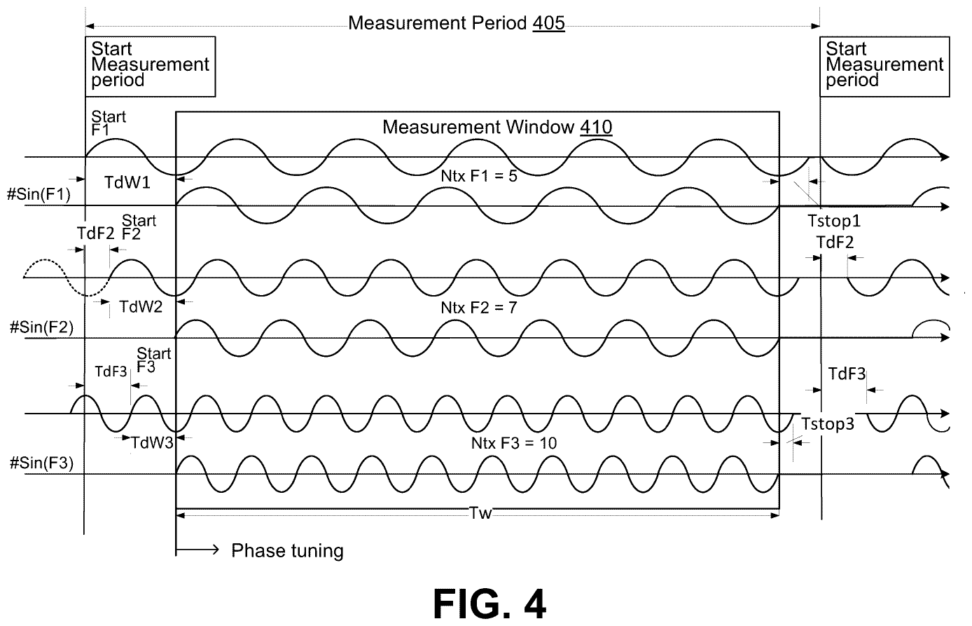

FIG. 4 is a signal timing graph illustrating timing of operation of drive signals of different frequencies being applied to different groups of electrodes in relation to a measurement period 405 and a measurement window 410 according to some embodiments. Because switching between phases should be performed after the end of a measurement window (time during which the TX electrodes are excited and the RX electrodes are sensed), to avoid voltage spikes and unwanted emissions, phase switching is best performed when the drive (or excitation) signal from the TX side crosses zero.

Several options for zero-crossing switching can be considered. In one option, the sinusoidal wave generator can be switched when the signal crosses zero at each frequency. In this case, switching the signal at one frequency can overlap the measurement window at another frequency, creating a distortion in the measurements. This creates an additional challenge of synchronizing measurement windows between frequencies.

In a second option, switching can be performed when one of the excitation signals crosses zero, for example, the lowest frequency signal. In this approach, a second drive signal can be switched to anti-phase when its value is not zero. This causes an increase in radiation and a large current to recharge the parasitic capacitance of the TX electrode. In addition, the measurement window is shifted relative to the window of the signal that initiates the switching. Further, alignment of windows after subsequent switches is problematic.

In a third option, switching an be performed as in the second option, but restart the sinusoidal wave (or signal) generators after each switching. This strategy of switching removes the problem of the measurement window shifting (each subsequent measurement period 405 repeats the conditions of the first measurement period). In addition, the voltage surge amplitude is reduced by two times. However, increased radiation and current spikes, although reduced by a factor of two, are still present.

In some embodiments, to prevent unwanted TX voltage and current spikes, a control rule can be applied that the number of TX excitation signal periods (Ntx) in the measurement period 405 at each frequency be an integer. According to this rule, the set of the TX frequencies can be calculated as

$$F t x ( N t x ) = Nt x / T mes \qquad ( 1 )$$

where Tmes is the measurement time.

The inaccuracy in the generation of TX frequencies, which can be expressed as Ntx/Tmes, leads to an unacceptable shift in the zero-crossing time of the excitation signals at different frequencies after some time of operation. To solve this problem, control of the sinusoidal wave generators can cause a restart of the sinusoidal wave generators at the same time as switching the TX phase. Alignment of measurement periods 405 does not align measurement windows at different frequencies. As a result, the demodulator on one frequency captures tails from other frequencies, which creates crosstalk between frequencies.

Crosstalk is the result of synchronous rectification of a repetitive signal. This means that the crosstalk of these signals at the other frequency is a constant value that can be considered as a baseline. The crosstalk value changes only if the touch sensor is touched. If touched, approximately 10% of unit-cell capacitance value of crosstalk variation is less than 0.45%. This variation is negligible for purposes of touch recognition in disclosed embodiments.

With reference to FIG. 4, the problem of crosstalk can be solved by setting the same duration of each measurement window at each frequency so that each measurement window (at a respective frequency) contains an integer number of periods of the drive signal. This requirement can be satisfied if the drive signals at different frequencies have a peak value at the edges of the measurement window, as illustrated (where “Start Fx” signals the beginning of each measurement period 405 before the drive signal enters the measurement window 410). In this case, drive signals from the touch sensor, as well as digital sinusoidal signals (for demodulation at the RX side), cross zero at these moments as well.

In some embodiments, the measurement window 410 starts after a first fraction of a TX excitation period of time delay (TdWx) to prevent impact of transients after the drive signal starts. For example, the first fraction can be ½ or ¾ or the like. A length of the measurement period 405 can be determined by the lowest excitation frequency (F1 in FIG. 4), which can be considered a “base” or lowest frequency for the MFTX architecture. Excitation or drive signals at higher frequencies can begin with a time delay (TdFx) after the start of the base frequency signal. The effects of TdFx across frequencies is that each drive signal enters the measurement window 410 at the same point in TX excitation period of each drive signal.

In embodiments, generation of the drive signal stops after the end of the measurement window 410 with a delay Tstop_x corresponding to a second fraction of the TX excitation period of the corresponding drive signal. The drive signal can remain at zero until it is activated in the next measurement period. In some embodiments, the second fraction can be the TX excitation period minus the first fraction, such as ½ or a ¼ of the TX excitation period corresponding to a first fraction of ½ or ¾, respectively.

The basis for calculating the TX excitation period timing parameters for the drive signals is the desired value of the measurement period (Tmes) and the lowest TX frequency (Ftx1, such as F1). Since the digital-based components are synchronized by a clock frequency Folk, timing parameters can be determined in number of clocks pulses. The measurement period duration in number of clocks can be expressed as

$$\# Tmes = floor ( Tmes \cdot Fclk ) . \qquad ( 2 )$$

The integer number of TX excitation periods within the measurement period 405 for the base frequency can be expressed as:

$$Nmes 1 = floor ( \# Tmes \cdot Ftx 1 / Fclk ) . \qquad ( 3 )$$

A minimal excitation frequency that can set for calculated measurement period 405 can expressed as:

$$\# Ftx 1 = Nmes 1 \cdot Fcl k / \# Tmes . \qquad ( 4 )$$

In some embodiments, the number of TX excitation periods within the measurement window 410 for the base frequency can be expressed as:

$$Ntx 1 = Nmes 1 - 1 , \qquad ( 5 )$$

Which is to say that the measurement window 410 is a TX excitation period shorter than the measurement period 405. The set of Ftx frequencies can be expressed as

$$\# {Ftx}_{n} = \# Ftx 1 \cdot \frac{Ntx 1 + ( n - 1 )}{Ntx 1} ; n = 1 , 2 , … \qquad ( 6 )$$

The number of TX excitation periods within the measurement window 410 for each frequency can be expressed as:

$${Ntx}_{n} = Ntx 1 + ( n - 1 ) ; n = 1 , 2 , … \qquad ( 7 )$$

In some embodiments, the delay to starting to operate the drive signal can be expressed as:

$$\# {TdF}_{n} = round ( \frac{3 \cdot Fclk}{4 \cdot \# Ftx 1} - \frac{3 \cdot Fclk}{4 \cdot \# {Ftx}_{n}} ) , \qquad ( 8 )$$

where Fclk is the system clock on which is based the control timing, which will be discussed in more detail. Further, the delay to the start of the measurement window 410 can be expressed as:

$$\# {TdW}_{n} = round ( \frac{3 \cdot Fclk}{4 \cdot {Ftx}_{n}} ) . \qquad ( 9 )$$

The delay after the measurement window 410 to stop generation of the drive signal can be expressed as:

$$\# {Tstop}_{n} = round ( \frac{Fclk}{4 \cdot Ft {x}_{n}} ) \qquad ( 10 )$$

The measurement window 410 itself can be expressed a frequency-dependent way as:

$$Tw = round ( \frac{Nt x min \cdot Fclk}{Ftx min} ) . \qquad ( 10 )$$

The drive signal generated by a sinusoidal wave generator can be fed to a corresponding demodulator via the TX driver, TX electrode of the touch sensor, and a current mode digitizer, which path introduces a delay. This delay can be compensated for during a tuning procedure by adding, to the TdW delay, a value of delay (Ph) that is common to all frequencies.

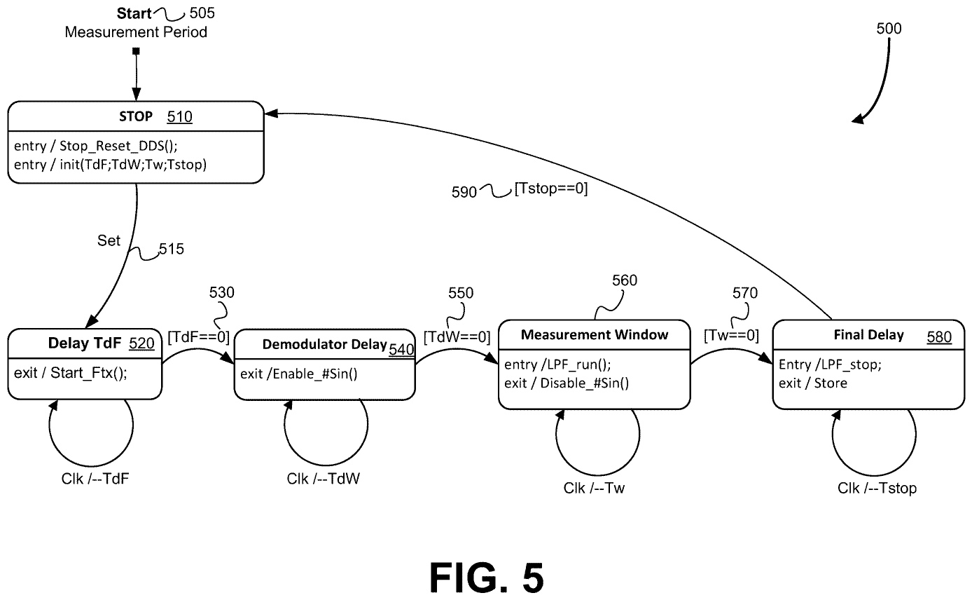

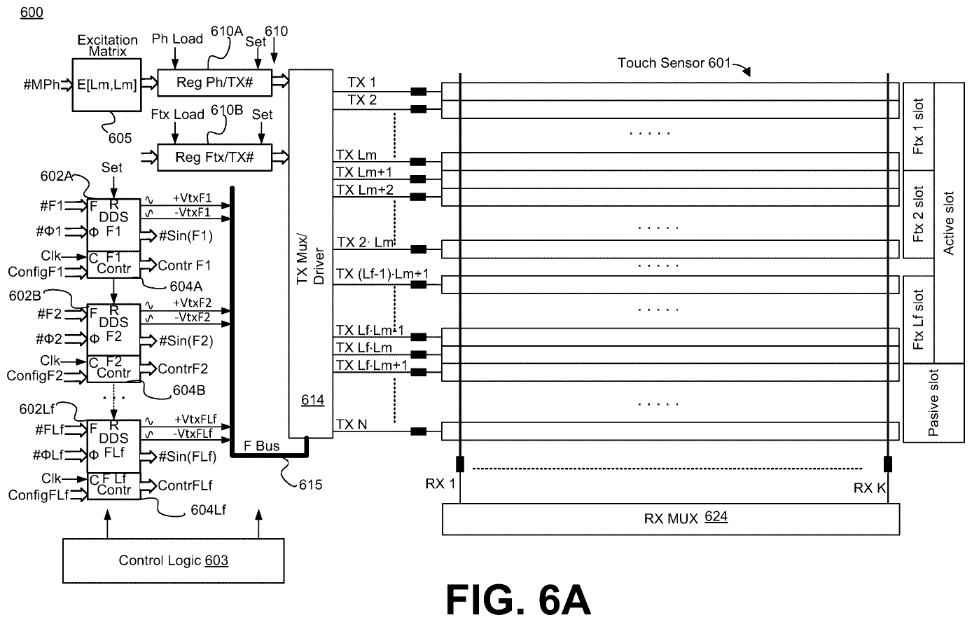

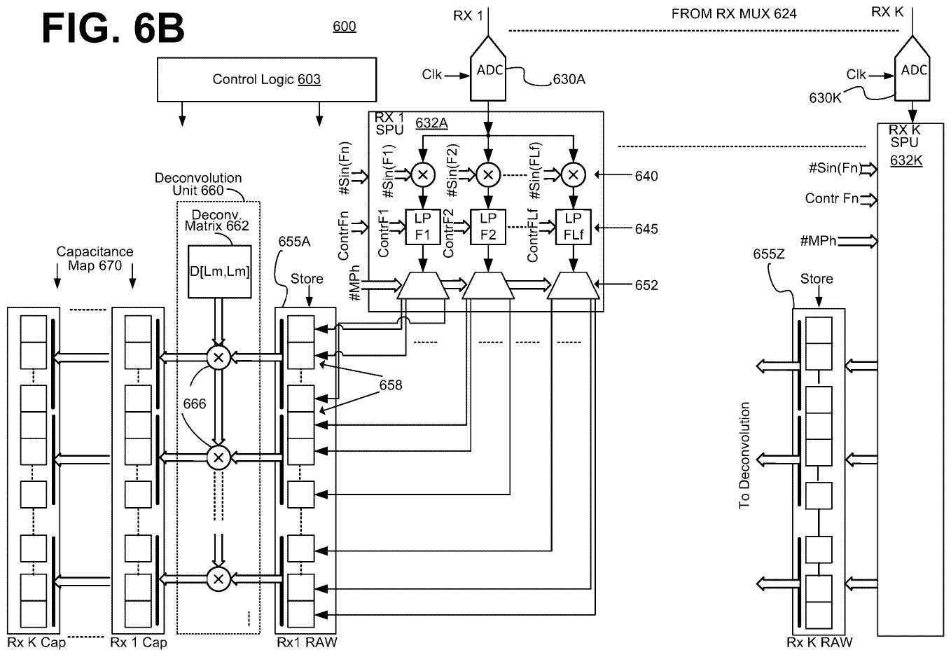

FIG. 5 is a flow chart illustrating a method 500 of implementing a control logic that controls each of at least some of the sinusoidal wave generators 602A-602Lf (FIG. 6A) that generate drive signals at different frequencies according to the timing explained with reference to FIG. 4 according to some embodiments. For example, in embodiments, the sinusoidal wave generator for each frequency can operate according to a state machine that carries out the operations of the method 500. Thus, to simplify this discussion, assume that control or processing logic is being executed to control a single sinusoidal wave generator that generates a drive signal at a particular frequency and a digital sinusoidal signal that is phase shifted compared to the drive signal.

At operation 505, after activation, the control logic enters a STOP state in which the sinusoidal wave generator is reset and initiated with a plurality of input parameters or variables associated with different delay periods or timing discussed with reference to FIG. 4, e.g., TdF, TdW, Tw, and Tstop.

At operation 515, the control logic asserts a “Set” signal that leads to a transitional delay of the TdF state.

At operation 520, the control logic enters a delay TdF state during which the TdF variable is decremented each clock cycle until reaching zero.

At operation 530, in response to the TdF variable reaching zero, and before transitioning to the next state, the control logic activates the sinusoidal wave generator, which becomes operational.

At operation 540, the control logic transitions to a demodulator delay state. The demodulator delay can be implemented by decrementing the TdW variable each clock cycle until reaching zero.

At operation 550, in response to the TdW variable reaching zero and before moving to the next state, the digital sinusoidal signal # Sin( ) is activated, e.g., by running an enable_# Sin( ) routine. Functionality of the digital sinusoidal signal will be discussed in more detail with reference to FIG. 6B.

At operation 560, the control logic enters a measurement window state and activates the LPF in the signal processing unit (SPU), e.g., by running a LPF_run( ) routine. At operation 560, a measurement window delay (Tw) can be tracked by decrementing the Tw variable at each clock cycle until reaching zero.

At operation 570, in response to the Tw variable reaching zero and before moving to the next state, the control logic disables the digital sinusoidal signal # Sin ( ) e.g., by running a disable_# Sin( ) routine.

At operation 580, the control logic enters a final delay state that stops the LPF filtering operation in the SPU. The final delay (Tstop) can be implemented by decrementing the Tstop variable at each clock cycle until reaching zero.

At operation 590, in response to the Tw variable reaching zero and before moving to the next state, the control logic generates an LPF data store signal so that the demodulated signals within the SPU can a particular MPTX phases can be stored to memory, as will be discussed in more detail with reference to FIG. 6B. The method 500 then loops back to the stop state at operation 510 in wait for the next “set” signal.

FIGS. 6A-6B are a schematic block diagram of a capacitance-sensing apparatus 600 (or device or system) with circuitry that drives a touch sensor with multi-frequency and multi-phase signals according to some embodiments. In embodiments, the apparatus 600 includes a touch sensor 601 having a plurality of TX electrodes coupled to corresponding TX lines and a plurality of RX electrodes coupled to corresponding RX lines. The TX electrodes and the RX electrodes cross an unit cell locations that operate with mutual and self capacitances that can be sensed when measuring the touch sensor 601 to detect a touch (such as a human touch).

The touch sensor 601 can be connected to a touch controller (components of which are discussed hereafter) using a TX electrodes multiplexer/driver 614 (or TX Mux/Drv) coupled to the TX electrodes and an RX electrodes multiplexer 624 (RX MUX) coupled to the RX electrodes. These multiplexer/driver units can be responsible for adapting the resources of the sensor controller to touch sensors 601 of different designs, such as multiplexing signal drivers between differing number of TX electrodes and/or RX electrodes.

In some embodiments, the apparatus 600 includes a plurality of sinusoidal wave generators 602A-602Lf configured to generate, over a signal bus 615 coupled to a plurality of TX electrodes of a touch sensor 601, multiple sets of drive signals at different frequency and phase combinations and corresponding digital sinusoidal signals. In embodiments, the corresponding digital sinusoidal signals are generated for use in corresponding demodulation by a signal processing unit (SPU) coupled to the RX electrodes of the touch sensor 601, as will be discussed with reference to FIG. 6B.

For example, a first sinusoidal wave generator 602A can generate a first in-phase drive signal (+VtxF1), a first opposite-phase drive signal (−VtxF1), and a first digital sinusoidal signal (# Sin(F1)). A second sinusoidal wave generator 602B can generate a second in-phase drive signal (+VtxF2), a second opposite-phase drive signal (−VtxF2), and a second digital sinusoidal signal (# Sin(F2)). Additional sinusoidal wave generators can be included up through a final sinusoidal wave generator 602Lf, which can generate a final in-phase drive signal (+VtxFLf), a final opposite-phase drive signal (−VtxFLf), and a final digital sinusoidal signal (# Sin(FLf)).

In some embodiments, the apparatus 600 includes a plurality of control circuits 604A-604Lf coupled to the plurality of sinusoidal wave generators and configured to control, based on a frequency of a clock signal (Clk), timing of generation of the multiple sets of drive signals and the corresponding digital sinusoidal signals that are phase-shifted compared to a respective drive signal. For example, a first control circuit 604A can be coupled to the first sinusoidal wave generator 602A, a second control circuit 604B can be coupled to the second sinusoidal wave generator 602B, up through a final control circuit 604Lf can be coupled to a final sinusoidal wave generator 602Lf. In embodiments, each of these control circuits is configured to perform the control or state machine logic discussed with reference to FIGS. 4-5. For example, the control circuits 604A-605Lf can generate a plurality of frequency control signals, each useable to trigger a respective LPF of the plurality of LPFs 645 (see FIG. 6B) with measurement window timing corresponding to a particular frequency.

In embodiments, the apparatus 600 includes control logic 603 coupled to the plurality of sinusoidal wave generators 602A-602Lf and the plurality of control circuits 604Lf. In some embodiments, for purposes of explanation, the control logic 603 causes a first drive signal (VtxF1), generated by the first sinusoidal wave generator 602A at a first frequency (F1) and a first set of phases (#Φ1), to be applied to a first group of the plurality of TX electrodes (Tx1-TxLm). The control logic 603 can further cause a first digital sinusoidal signal # Sin(F1) corresponding to the first drive signal to be provided to the signal processing unit (SPU). In embodiments, the input frequencies (#Fn) and phases (#@n) can be loaded using codes and the control circuits can be operated based on input configuration parameters or variables (ConfigFn) and synchronize operations of the sinusoidal wave generators off of a common clock signal (Clk).

In embodiments, the control logic 603 causes a second drive signal (VtxF2), generated by the second sinusoidal wave generator 602B at a second frequency (F2) and a revised set of phases (#Φ2), to be applied to a second group (LX Lm+1 to TX2·Lm) of the plurality of TX electrodes. The control logic 603 can further cause a second digital sinusoidal signal # Sin(#F2) corresponding to the second drive signal to be provided to the signal processing unit (SPU). In embodiments, each revised set of phases #Φx can be shifted to, in additional to the phase manipulation performed by each sinusoidal wave generator, compensates for signal delay over signals paths between a respective sinusoidal wave generator and a corresponding multiplier 640 (or demodulator), which are illustrated and discussed with reference to FIG. 6B.

In some embodiments, the first digital sinusoidal signal # Sin(F1) is phase-shifted compared to the first drive signal (VtxF1), the second digital sinusoidal signal # Sin(F2) is phase-shifted compared to the second drive signal (VtxF2). In embodiments, the second group of the plurality of TX electrodes is sequentially positioned adjacent to the first group of the plurality of TX electrodes. In this way, the control logic 603 can concurrently cause, over the signal bus 615, drive signals of different frequency and phase combinations to be applied to different electrode groups, which frequency and phase combinations can be changed in subsequent measurement periods as discussed with reference to FIGS. 3A-3B and FIGS. 4-5, thus implementing both MPTX and MFTX architectures simultaneously.

Further, consistent with the discussion of FIGS. 3A-3B and FIGS. 4-5, the control logic 603 can ensure a number of TX excitation periods in a measurement period 405 at each frequency of the different frequency and phase combinations is an integer value and/or ensure the number of TX excitation periods in a measurement window 410 at each frequency is an integer value, where the measurement window 410 is smaller than the measurement period 405. In embodiments, the measurement window is a TX excitation period shorter than the measurement period. The control logic 603 can further reset the plurality of sinusoidal wave generators at a beginning of each measurement period.

In some embodiments, the first control circuit 604A causes the first drive signal (VtxF1) to start operating at the beginning of a measurement period. The second control circuit 604B can cause the second drive signal (VtxF2) to be delayed by a first fraction of a TX excitation period into the measurement period 405. In embodiments, the second control circuit 604B determines the first fraction of the TX excitation period so that the first and second drive signals enter the measurement window 410, within the measurement period 405, at a matching location in signal period. In embodiments, each of the first control circuit 604A and the second control circuit 604B further causes the first drive signal and the second drive signal, respectively, to stop operating after a second delay from an end of the measurement window, the second delay including a second fraction of the TX excitation period.

In various embodiments, the first control circuit 604A further generates a first frequency control signal (Contr1) to indicate, to a first low-pass filter (LPF1) coupled to an RX electrode, timing for activation of the first LPF. Further, the second control circuit 604B can further generate a second frequency control signal (Contr2) to indicate, to a second LPF (or LPF2) coupled to the RX electrode, timing for activation of the second LPF2. The first and second LPFs will be discussed in more detail with reference to FIG. 6B.

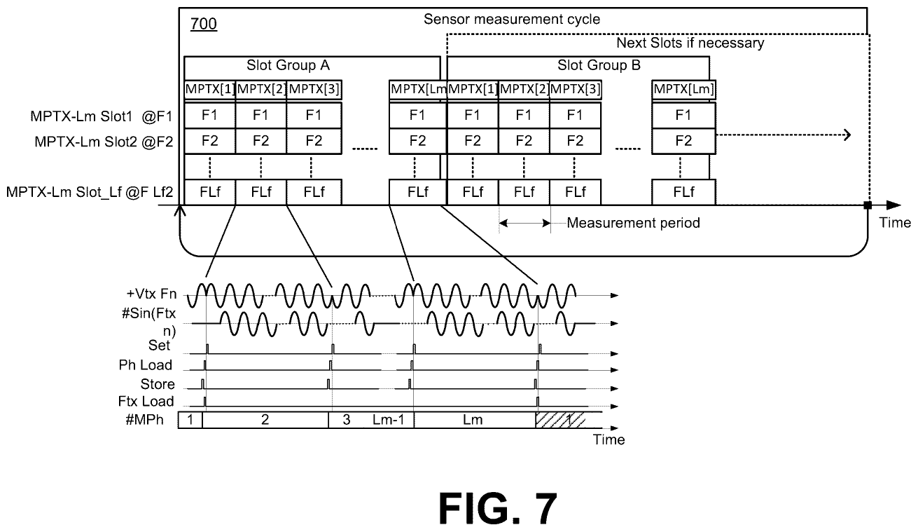

In some embodiments, the apparatus 600 includes memory 610 that includes, for example, one or more first registers 610A to store multi-phase patterns to be applied to the TX electrodes (e.g., within different groups of TX electrodes) and one or more second registers 610B to store multi-frequency patterns to be applied to the TX electrodes. For example, the one or more first registers 610A can include a first block of registers to store an excitation matrix having the same or different phase patterns to be applied to respective ones (or groups) of the plurality of TX electrodes and the one or more second registers 610B can include a second block of registers to store frequencies at which to excite respective ones (or groups) of the plurality of TX electrodes. In embodiments, the control logic 603 controls shifting new values into the first block of registers and the second block of registers in between measurement periods (see FIG. 7).

In some embodiments, the control logic 603 further retrieves, from the excitation matrix in the memory 610, a first multi-phase pattern corresponding to the set of phases and a second multi-phase pattern corresponding to the set of phases. After a first measurement window has completed, the control logic 603 can cause, during a second measurement window, the first sinusoidal wave generator 602A to generate the first drive signal at the first frequency and the set of phases and cause the second sinusoidal wave generator 602B to generate the second drive signal at the second frequency and the set of phases.

With further reference to FIG. 6B, in some embodiments, the apparatus 600 includes a number of ADCs 630A-630K coupled to the RX electrodes multiplexer 624 and a corresponding number of RX signal processing units or RX SPUs 632A-632K coupled to respective ones of the ADCs 630A-630Z. For an exemplary RX measurement signal path, a first ADC 630A is coupled to a first RX electrode (RX1) of the touch sensor 601 that is capacitively coupled to a plurality of TX electrodes. Sensor signals from the RX electrodes can be received by ADC input through the RX electrodes multiplexer 624. The first ADC 630A can have a current input and can be based on or designed as a sigma-delta modulator (SDM). The result of digitizing the sensor signal is sent to an SPU, where it is demodulated and filtered.

For example, a first SPU 632A can be coupled to the first ADC 630A. In embodiments, the first SPU 632A includes a plurality of multipliers 640 (also referred to as demodulators), each multiplier to demodulate a digital signal received from the first ADC 630A using a digital sinusoidal signal # Sin(Fn) at a phase-shifted one of a plurality of frequencies used to excite a group of the plurality of TX electrodes. More specifically, each multiplier can perform synchronous demodulation of the digitized sensor signal by multiplying the digitized sensor signal by the corresponding digital sinusoidal signal # Sin(Fn) during the measurement window.

The first SPU 632A can further include a plurality of low-pass filters (or LPFs 645) coupled to the plurality of multipliers 640. In embodiments, each LPF generates a direct-current (DC) signal of the demodulated digital signal received from a multiplier of the plurality of multipliers 640. Each LPF, for example, can separate the DC component of the demodulated signal, which represents the magnitude of the sensor signal at the demodulator frequency. In some embodiments, the number of the plurality of multipliers 640 (or demodulators) and plurality of LPFs 645 can correspond to the number of frequencies (Lf) employed by the MFTX architecture. The passband of each chain of multiplier is equal to twice the passband of LPF. Since each multiplier 640 operates at a different demodulator frequency and with a different measurement window duration, each LPF 645 is controlled by separate ContrFn control signals. The SPU structure for all other channels can be the same.

In some embodiments, the first SPU 632A further includes a plurality of demultiplexers 652 coupled to respective ones of the plurality of LPFs 645, each demultiplexer being controlled by a phase selection signal (#Mph) used to select from a set of phases for a corresponding drive signal used to excite the group of the plurality of TX electrodes. In such embodiments, the apparatus 600 further includes a memory 655A coupled to the first SPU 632A and a memory 655Z coupled to a final SPU 632K. In some embodiments, the memory 655A is the same as the memory 610 (FIG. 6A) or is additional memory dedicated to the RX measurement channels. In at least some embodiments, the memory 655A includes a plurality of registers 658, each register coupled to a different output of a respective demultiplexer of the plurality of demultiplexers 652 and configured to store modulated values of the DC signal at a particular frequency and phase combination.

In embodiments, at the end of the measurement window, each LPF contains the corresponding measurement result that represents the measurement response to the #MPh MPTX excitation pattern. This data can be stored in response to a “Store” signal in the raw data memory (e.g., the memory 655A) with index #MPh. This function can be implemented with a demultiplexer at the LPF output for each frequency Ftx in each measurement channel. After measurements for all MPTX patterns are stored in the memory 655A, the deconvolution procedure is performed.

In embodiments, the apparatus 600 further includes a deconvolution unit 660 that includes a deconvolution matrix 662. The deconvolution matrix 662 can include an inverse matrix set of values that were used to generate each corresponding drive signal employed to excite the group of the plurality of TX electrodes, for example. The deconvolution unit 660 can further include a multiplier 666 coupled to a set of the plurality of registers 658 associated with the group of the plurality of TX electrodes. In embodiments, the multiplier 666 is configured to multiply a vector of values in the set of the plurality of registers 658 by the deconvolution matrix 662 (or D[Lm,Lm]) to generate a set of sensing values. The multiplier 666 can further store the set of sensing values in a capacitive data memory 670, the unit cells of which correspond to locations of unit cells the touch sensor 601. In embodiments, a unit cell means each crossing of the TX and RX electrodes in the touch sensor 601. For example, the capacitive data memory 670 can store a capacitance map corresponding to respective unit cell locations of the touch sensor 601. This procedure can be performed on the data for each frequency in each RX measurement channel.

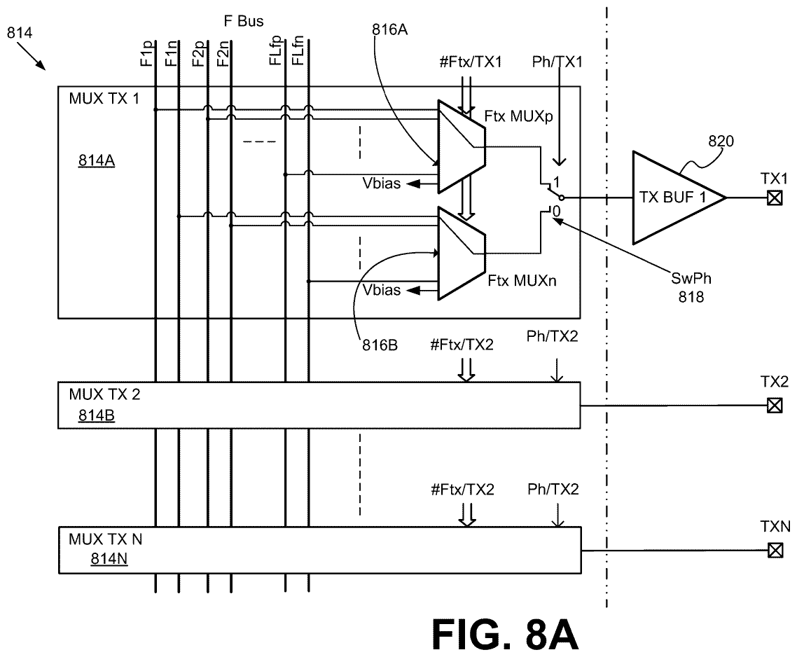

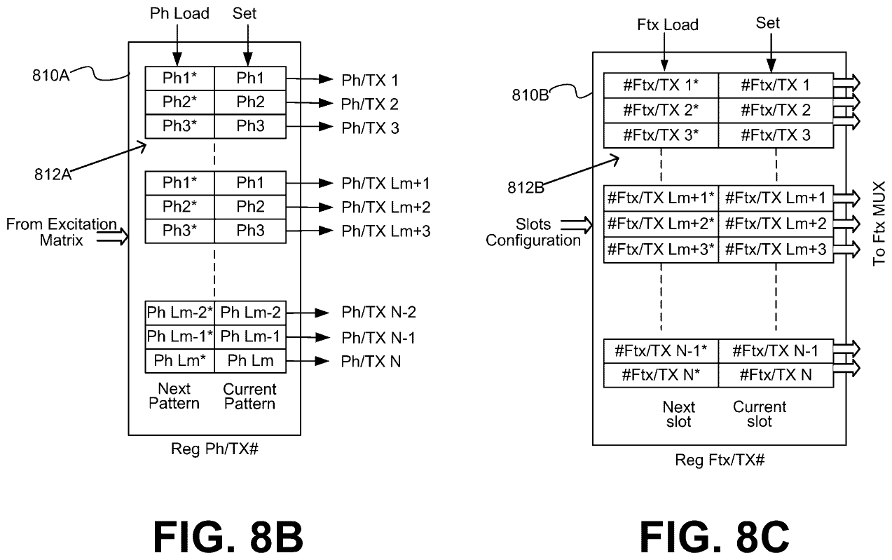

FIG. 7 is a timing graph associated with the schematic TX electrode-based flow diagram of FIG. 3A illustrating timing of different control signals on generating the multi-frequency and multi-phase excitation technology according to exemplary embodiments. The diagram shows the excitation (+Vtx Fn), demodulation (# Sin(Ftx n), and control signals (Set, Ph Load, Store, Ftx Load, #MPh) in time for the measurement periods inside and at the end of an active slot, as these signals are illustrated and discussed with reference to FIGS. 6A-6B and FIGS. 8A-8B.

FIG. 8A is a schematic circuit diagram illustrating an exemplary TX electrodes multiplexer driver 814 for implementing the apparatus 600 (or device or system) of FIG. 6A-6B according to some embodiments. In embodiments, the TX electrodes multiplexer driver 814 transports frequency bus (F Bus) signals through TX buffers to the TX electrodes. FIG. 8B is an example first memory 810A for storing the same or different phase patterns corresponding to groups of electrodes to implement the MPTX technology through the exemplary TX electrodes multiplexer driver 814 (FIG. 8A) according to some embodiments. For example, the first memory 810A can include a first block of registers 812A to store an excitation matrix with the same or different phase patterns to be applied to respective ones of the plurality of TX electrodes. FIG. 8C is an example second memory 610B for storing different frequencies corresponding to the groups of electrodes to implement the MFTX technology through the exemplary TX electrodes multiplexer driver (FIG. 8A) according to some embodiments. For example, the second memory 810B can include a second block of registers to store frequencies (or frequency indicators) at which to excite respective ones of the plurality of TX electrodes.

In some embodiments, the TX electrodes multiplexer driver 814 can include a plurality of drive multiplexers 814 (i.e. MUX T×n sub-blocks within the TX electrodes multiplexer/driver 614) that are responsive to values, received from the first block of registers 812A and the second block of registers 812B of the first memory 810A and the second memory 810B, respectively, for each TX electrode to which a respective drive multiplexer is coupled. For example, the TX electrodes multiplexer driver 814 can include a first drive multiplexer 814A to drive a first electrode (TX1), a second drive multiplexer 814B to drive a second electrode (TX2), and so forth up through an Nth drive multiplexer 814N to drive an Nth electrode (TXN), each generally structured the same.

In an exemplary embodiment, for purposes of explanation, the first drive multiplexer 814A includes a first frequency multiplexer 816A to choose from a plurality of in-phase drive signals (retrieved from the first block of registers 812A) and a second frequency multiplexer 816B to choose from a plurality of opposite-phase drive signals (retrieved from the first block of registers 812A). In embodiments, each of the first frequency multiplexer 816A and the second frequency multiplexer 816B are controlled by an output from the second block of registers 812B. The first drive multiplexer 814A can further include a switch 818 coupled between outputs of the first and second frequency multiplexers 816A and 816B and an input to a TX buffer 820 for a TX electrode. In embodiments, the switch 818 is controllable by an output of the first block of registers 812A. In some embodiments, each of the first frequency multiplexer 816A and the second frequency multiplexer 816B include a voltage bias input (Vbias) that is selectable when a coupled TX electrode is unused for an upcoming measurement period.

With additional reference to FIGS. 8A-8C, each group of TX electrodes can be programmed to be driven by the same frequency by writing the same data in the corresponding cells to form the Ftx slot in the second block of registers 812B. In embodiments, the number of frequency multiplexers in a drive multiplexer is equal to the number of components in the MPTX Lm template. Frequency allocation data can be written to (or loaded in) the second memory 810B (Reg Ftx/TX #) before measuring the active slot. The unused electrodes can be connected to Vbias by writing the appropriate data to their control register cells, e.g., within the second block of registers 812B. Since a single-supply system is expected, Vbias can be treated as the bias of a sinusoidal signal.

In some embodiments, the phase of a TX electrode is controlled by the output bits from the first block of registers 812A of the first memory 810A. Each bit refers to one of the frequency multiplexers 816A or 816B. Bits can be grouped into slots in the same way as frequencies are grouped into frequency slots. The state of the bit determines the phase (for example, a one value (“1”) is forward phase while a zero value (“0”) is opposite phase). The data in the first block of registers 812A can be overwritten with a new pattern at the end of the measurement period and sent to the switches when the phases are switched by the “Set” signal. The bit state of the inactive electrodes does not matter.

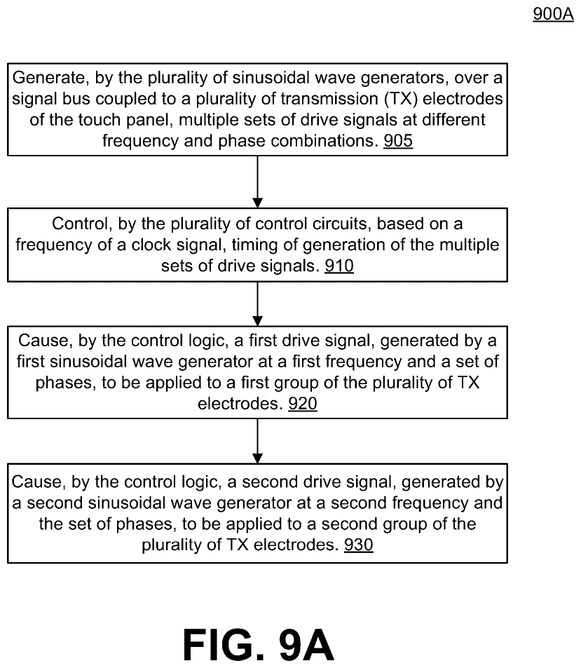

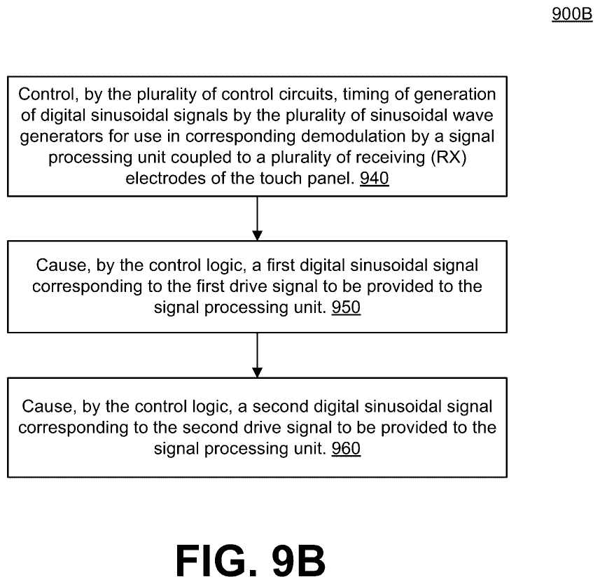

FIG. 9A is a flow chart of a method 900A for operating the apparatus 600 (or device or system) of exciting a touch sensor so as to employ both MPTX and MFTX technologies on groups of electrodes according to some embodiments. Method 900A can be performed by processing logic comprising hardware, firmware, or any combination thereof. Method 900A can be performed by the apparatus 600 of FIGS. 6A-6B, to include the sinusoidal wave generators 602A-602Lf, the control circuits 604A-604Lf, and the control logic 603, and by the TX electrodes multiplexer driver 814 of FIG. 8A.

At operation 905, the method 900A includes generating, by the plurality of sinusoidal wave generators, over a signal bus coupled to a plurality of transmission (TX) electrodes of the touch sensor, multiple sets of drive signals at different frequency and phase combinations.

At operation 910, the method 900A includes controlling, by the plurality of control circuits, based on a frequency of a clock signal, timing of generation of the multiple sets of drive signals.

At operation 920, the method 900A includes causing, by the control logic, a first drive signal, generated by a first sinusoidal wave generator at a first frequency and a set of phases, to be applied to a first group of the plurality of TX electrodes.

At operation 930, the method 900A includes causing, by the control logic, a second drive signal, generated by a second sinusoidal wave generator at a second frequency and the set of phases, to be applied to a second group of the plurality of TX electrodes.

FIG. 9B is a flow chart of a method 900B for operating the apparatus 600 (or device of system) so as to control timing of generation of digital sinusoidal signals, corresponding to the MPTX and MFTX drive signals (FIG. 9A), for use in demodulation by a signal processing unit coupled to RX electrodes of the apparatus (or device or system) according to some embodiments.

At operation 940, the method 900B includes controlling, by the plurality of control circuits, timing of generation of digital sinusoidal signals by the plurality of sinusoidal wave generators for use in corresponding demodulation by a signal processing unit coupled to a plurality of receiving (RX) electrodes of the touch sensor.

At operation 950, the method 900B includes causing, by the control logic, a first digital sinusoidal signal corresponding to the first drive signal to be provided to the signal processing unit.

At operation 960, the method 900B includes causing, by the control logic, a second digital sinusoidal signal corresponding to the second drive signal to be provided to the signal processing unit.

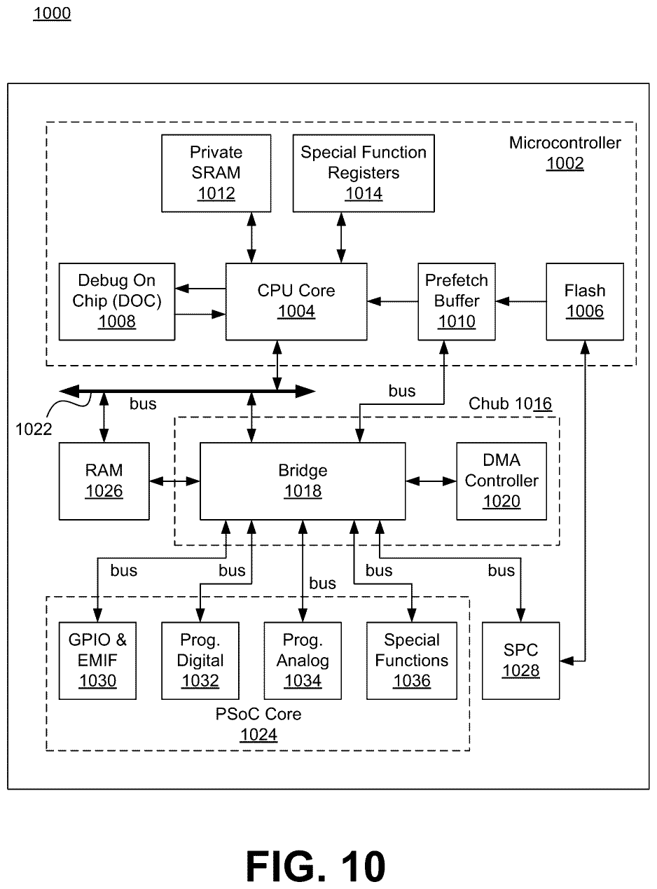

FIG. 10 illustrates an embodiment of a core architecture 1000 of the PSoC® processing device, such as that used in the PSoC3® family of products offered by Cypress Semiconductor Corporation (San Jose, California). In one embodiment, the core architecture 1000 includes a microcontroller 1002. The microcontroller 1002 includes a CPU (central processing unit) core 1004, flash program storage 1006, DOC (debug on-chip) 1008, a prefetch buffer 1010, a private SRAM (static random access memory) 812, and special functions registers 1014. In an embodiment, the DOC 1008, prefetch buffer 1010, private SRAM 1012, and special function registers 1014 are coupled to the CPU core 1004, while the flash program storage 1006 is coupled to the prefetch buffer 1010.

The core architecture 1000 may also include a CHub (core hub) 1016, including a bridge 1018 and a DMA controller 1020 coupled to the microcontroller 1002 via bus 1022. The CHub 1016 may provide the primary data and control interface between the microcontroller 1002 and its peripherals and memory, and a programmable core 1024. In one embodiment, the timing control circuitry of FIGS. 6A-6B may be implemented in the core architecture 1000, such as part of the programmable core 1024. The DMA controller 1020 may be programmed to transfer data between system elements without burdening the CPU core 1004. In various embodiments, each of these subcomponents of the microcontroller 1002 and CHub 1016 may be different with each choice or type of CPU core 1004. The CHub 1016 may also be coupled to a shared SRAM 1026 and an SPC (system performance controller) 1028. The private SRAM 1012 is independent of the shared SRAM 1026 accessed by the microcontroller 1002 through the bridge 1018. The CPU core 1004 accesses the private SRAM 1012 without going through the bridge 1018, thus allowing local register and RAM accesses to occur simultaneously with DMA access to shared SRAM 1026. Although labeled here as SRAM, these memory modules may be any suitable type of a wide variety of (volatile or non-volatile) memory or data storage modules in various other embodiments.

In various embodiments, the programmable core 1024 may include various combinations of subcomponents (not shown), including, but not limited to, a digital logic array, digital peripherals, analog processing channels, global routing analog peripherals, DMA controller(s), SRAM and other appropriate types of data storage, IO ports, and other suitable types of subcomponents. In one embodiment, the programmable core 1024 includes a GPIO (general purpose IO) and EMIF (extended memory interface) block 1030 to provide a mechanism to extend the external off-chip access of the microcontroller 1002, a programmable digital block 1032, a programmable analog block 1034, and a special functions block 1036, each configured to implement one or more of the subcomponent functions. In various embodiments, the special functions block 1036 may include dedicated (non-programmable) functional blocks and/or include one or more interfaces to dedicated functional blocks, such as USB, a crystal oscillator drive, JTAG, and the like.

The programmable digital block 1032 may include a digital logic array including an array of digital logic blocks and associated routing. In one embodiment, the digital block architecture is comprised of UDBs (universal digital blocks). For example, each UDB may include an ALU together with CPLD functionality.

In various embodiments, one or more UDBs of the programmable digital block 832 may be configured to perform various digital functions, including, but not limited to, one or more of the following functions: a basic I2C slave; an I2C master; an SPI master or slave; a multi-wire (e.g., 3-wire) SPI master or slave (e.g., MISO/MOSI multiplexed on a single pin); timers and counters (e.g., a pair of 8-bit timers or counters, one 16 bit timer or counter, one 8-bit capture timer, or the like); PWMs (e.g., a pair of 8-bit PWMs, one 16-bit PWM, one 8-bit deadband PWM, or the like), a level-sensitive I/O interrupt generator; a quadrature encoder, a UART (e.g., half-duplex); delay lines; and any other suitable type of digital function or combination of digital functions which can be implemented in a plurality of UDBs.

In other embodiments, additional functions may be implemented using a group of two or more UDBs. Merely for purposes of illustration and not limitation, the following functions can be implemented using multiple UDBs: an I2C slave that supports hardware address detection and the ability to handle a complete transaction without CPU core (e.g., CPU core 804) intervention and to help prevent the force clock stretching on any bit in the data stream; an I2C multi-master which may include a slave option in a single block; an arbitrary length PRS or CRC (up to 32 bits); SDIO; SGPIO; a digital correlator (e.g., having up to 32 bits with 4x over-sampling and supporting a configurable threshold); a LINbus interface; a delta-sigma modulator (e.g., for class D audio DAC having a differential output pair); an I2S (stereo); an LCD drive control (e.g., UDBs may be used to implement timing control of the LCD drive blocks and provide display RAM addressing); full-duplex UART (e.g., 7-, 8- or 9-bit with 1 or 2 stop bits and parity, and RTS/CTS support), an IRDA (transmit or receive); capture timer (e.g., 16-bit or the like); deadband PWM (e.g., 16-bit or the like); an SMbus (including formatting of SMbus packets with CRC in software); a brushless motor drive (e.g., to support 6/12 step commutation); auto BAUD rate detection and generation (e.g., automatically determine BAUD rate for standard rates from 1200 to 115200 BAUD and after detection to generate required clock to generate BAUD rate); and any other suitable type of digital function or combination of digital functions which can be implemented in a plurality of UDBs.

The programmable analog block 1034 may include analog resources including, but not limited to, comparators, mixers, PGAs (programmable gain amplifiers), TIAs (trans-impedance amplifiers), ADCs (analog-to-digital converters), DACs (digital-to-analog converters), voltage references, current sources, sample and hold circuits, and any other suitable type of analog resources. The programmable analog block 834 may support various analog functions including, but not limited to, analog routing, LCD drive IO support, capacitance-sensing, voltage measurement, motor control, current to voltage conversion, voltage to frequency conversion, differential amplification, light measurement, inductive position monitoring, filtering, voice coil driving, magnetic card reading, acoustic doppler measurement, echo-ranging, modem transmission and receive encoding, or any other suitable type of analog function.

It should be noted that the embodiments described above use an in-phase signal, opposite phase signal, and a reference signal. The in-phase and opposite phases may be used when using inverters or complementary output stages to generate these signals. Also, the in-phase and opposite phase signals may be used for simplifying the measurement by the ADC as +1 or −1 data signs. However, in other embodiments, different arbitrary phase signals may be used. For example, an in-phase signal and one or more out-of-phase signals may be used.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time-multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions. The computer-readable transmission medium includes, but is not limited to, electrical, optical, acoustical, or other forms of propagated signal (e.g., carrier waves, infrared signals, digital signals, or the like), or another type of medium suitable for transmitting electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. An apparatus comprising:
a plurality of sinusoidal wave generators configured to generate, over a signal bus coupled to a plurality of transmission (TX) electrodes of a touch sensor, multiple sets of drive signals at different frequency and phase combinations;
a plurality of control circuits coupled to the plurality of sinusoidal wave generators, the plurality of control circuits to control, based on a frequency of a clock signal, timing of generation of the multiple sets of drive signals; and
control logic coupled to the plurality of sinusoidal wave generators and the plurality of control circuits, the control logic to:
cause a first drive signal, generated by a first sinusoidal wave generator at a first frequency and a set of phases, to be applied to a first group of the plurality of TX electrodes; and
cause a second drive signal, generated by a second sinusoidal wave generator at a second frequency and the set of phases, to be applied to a second group of the plurality of TX electrodes.

2. The apparatus of claim 1, wherein the plurality of control circuits are also to control timing of generation of corresponding digital sinusoidal signals, by the plurality of sinusoidal wave generators, for use in corresponding demodulation by a signal processing unit coupled to a plurality of receiving (RX) electrodes of the touch sensor, wherein the control logic is further to:
cause a first digital sinusoidal signal corresponding to the first drive signal to be provided to the signal processing unit; and
cause a second digital sinusoidal signal corresponding to the second drive signal to be provided to the signal processing unit.

3. The apparatus of claim 2, wherein the first digital sinusoidal signal is phase-shifted compared to the first drive signal, the second digital sinusoidal signal is phase-shifted compared to the second drive signal, and wherein the second group of the plurality of TX electrodes is sequentially positioned adjacent to the first group of the plurality of TX electrodes.

4. The apparatus of claim 1, wherein the control logic is further to at least one of:
ensure a number of TX excitation periods in a measurement period at each frequency of the different frequency and phase combinations is an integer value; or
ensure the number of TX excitation periods in a measurement window at each frequency is an integer value, wherein the measurement window is smaller than the measurement period.

5. The apparatus of claim 4, wherein the measurement window is a TX excitation period shorter than the measurement period, and wherein the control logic is further to reset the plurality of sinusoidal wave generators at a beginning of each measurement period.

6. The apparatus of claim 1, wherein the plurality of control circuits comprises:
a first control circuit coupled to the first sinusoidal wave generator and to cause the first drive signal to start operating at a beginning of a measurement period; and
a second control circuit coupled to the second sinusoidal wave generator and to cause the second drive signal to be delayed by a first fraction of a TX excitation period into the measurement period, wherein the second control circuit determines the first fraction of the TX excitation period so that the first and second drive signals enter a measurement window, within the measurement period, at a matching location in signal period.

7. The apparatus of claim 6, wherein each of the first control circuit and the second control circuit is to further cause the first drive signal and the second drive signal, respectively, to stop operating after a second delay from an end of the measurement window, the second delay comprising a second fraction of the TX excitation period.

8. The apparatus of claim 6, wherein
the first control circuit is further to generate a first frequency control signal to indicate, to a first low-pass filter (LPF) coupled to an RX electrode, timing for activation of the first LPF; and
the second control circuit is further to generate a second frequency control signal to indicate, to a second LPF coupled to the RX electrode, timing for activation of the second LPF.

9. The apparatus of claim 1, wherein the control logic is further to:
retrieve, from an excitation matrix in memory, a first multi-phase pattern corresponding to the set of phases and a second multi-phase pattern corresponding to the set of phases; and
after a first measurement window has completed:
cause, during a second measurement window, the first sinusoidal wave generator to generate the first drive signal at the first frequency and the set of phases; and
cause the second sinusoidal wave generator to generate the second drive signal at the second frequency and the set of phases.

10. The apparatus of claim 1, further comprising:
a first block of registers to store an excitation matrix comprising different phase patterns to be applied to respective ones of the plurality of TX electrodes; and
a second block of registers to store frequencies at which to excite respective ones of the plurality of TX electrodes; and
wherein the control logic is to control shifting new values into the first block of registers and the second block of registers in between measurement periods.

11. The apparatus of claim 10, further comprising a plurality of drive multiplexers that are responsive to values, received from the first block of registers and the second block of registers, for each TX electrode to which a respective drive multiplexer is coupled, wherein each drive multiplexer comprises:
a first frequency multiplexer to choose from a plurality of in-phase drive signals;
a second frequency multiplexer to choose from a plurality of opposite-phase drive signals, wherein each of the first frequency multiplexer and the second frequency multiplexer are controlled by an output from the second block of registers; and
a switch coupled between outputs of the first and second frequency multiplexers and an input to a TX buffer for a TX electrode, wherein the switch is controllable by an output of the first block of registers.

12. The apparatus of claim 11, wherein each of the first frequency multiplexer and the second frequency multiplexer comprise a voltage bias input that is selectable when a coupled TX electrode is unused for an upcoming measurement period.

13. A system comprising:
an analog-to-digital converter (ADC) coupled to a receiving (RX) electrode of a touch sensor that is capacitively coupled to a plurality of transmission (TX) electrodes; and
an signal processing unit (SPU) coupled to the ADC, wherein the SPU comprises:
a plurality of multipliers, wherein each multiplier is to demodulate a digital signal received from the ADC using a digital sinusoidal signal at a phase-shifted one of a plurality of frequencies used to excite a group of the plurality of TX electrodes; and
a plurality of low-pass filters (LPFs) coupled to the plurality of multipliers, wherein each LPF is to generate a direct-current (DC) signal of the demodulated digital signal received from a multiplier of the plurality of multipliers.

14. A system of comprising
a plurality of transmission (TX) electrodes capacitive coupled to at least one receiving (RX) electrode;
a plurality of sinusoidal wave generators configured to generate, over a signal bus coupled to the plurality of TX electrodes of a touch sensor, multiple sets of drive signals at different frequency and phase combinations; and
a plurality of control circuits coupled to the plurality of sinusoidal wave generators, the plurality of control circuits to:
cause, based on a frequency of a clock signal, generation of the multiple sets of drive signals by the plurality of sinusoidal wave generators;
cause digital sinusoidal signals, which correspond to ones of the multiple sets of drive signals, to be generated by the plurality of sinusoidal wave generators for use in corresponding demodulation by a signal processing unit (SPU); and
generate a plurality of frequency control signals, each useable to trigger a respective LPF of a plurality of LPFs coupled to the plurality of multipliers with measurement window timing corresponding to a particular frequency.

15. The system of claim 14, further comprising control logic configured to reset the plurality of LPFs between measurement periods that comprise a measurement window associated with measuring the touch sensor using drive signals, each with a set of phases.

16. The system of claim 21, wherein the SPU further comprises a plurality of demultiplexers coupled to respective ones of the plurality of LPFs, each demultiplexer being controlled by a phase selection signal used to select from a set of phases for a corresponding drive signal used to excite the group of the plurality of TX electrodes.

17. The system of claim 16, further comprising a memory coupled to the SPU, the memory storing:
a plurality of registers, each register coupled to a different output of a respective demultiplexer of the plurality of demultiplexers and configured to store modulated values of the DC signal at a particular frequency and phase combination; and
a deconvolution matrix comprising an inverse matrix set of values that were used to generate each corresponding drive signal employed to excite the group of the plurality of TX electrodes.

18. The system of claim 17, further comprising a deconvolution unit comprising a multiplier coupled to a set of the plurality of registers associated with the group of the plurality of TX electrodes, wherein the multiplier is configured to:
multiply a vector of values in the set of the plurality of registers by the deconvolution matrix to generate a set of sensing values; and
store the set of sensing values in a capacitive data memory, cells of which correspond to locations of unit cells the touch sensor.

19. A method of operating an apparatus for exciting a touch sensor, the apparatus comprising a plurality of sinusoidal wave generators, a plurality of control circuits coupled to respective ones of the plurality of sinusoidal wave generators, and control logic coupled to the plurality of sinusoidal wave generators and control circuits, the method comprising:
generating, by the plurality of sinusoidal wave generators, over a signal bus coupled to a plurality of transmission (TX) electrodes of the touch sensor, multiple sets of drive signals at different frequency and phase combinations;
controlling, by the plurality of control circuits, based on a frequency of a clock signal, timing of generation of the multiple sets of drive signals;
causing, by the control logic, a first drive signal, generated by a first sinusoidal wave generator at a first frequency and a set of phases, to be applied to a first group of the plurality of TX electrodes; and
causing, by the control logic, a second drive signal, generated by a second sinusoidal wave generator at a second frequency and the set of phases, to be applied to a second group of the plurality of TX electrodes.

20. The method of claim 19, further comprising:
controlling, by the plurality of control circuits, timing of generation of digital sinusoidal signals by the plurality of sinusoidal wave generators for use in corresponding demodulation by a signal processing unit coupled to a plurality of receiving (RX) electrodes of the touch sensor;
causing, by the control logic, a first digital sinusoidal signal corresponding to the first drive signal to be provided to the signal processing unit; and
causing, by the control logic, a second digital sinusoidal signal corresponding to the second drive signal to be provided to the signal processing unit.

21. The system of claim 14, wherein the SPU comprises:
a plurality of multipliers, wherein each multiplier is to demodulate a digital signal received from an ADC coupled to the RX electrode using a digital sinusoidal signal at a phase-shifted one of a plurality of frequencies used to excite a group of the plurality of TX electrodes; and
wherein the plurality of low-pass filters (LPFs) coupled to the plurality of multipliers, wherein each LPF is to generate a direct-current (DC) signal of the demodulated digital signal received from a multiplier of the plurality of multipliers
